(19) United States
(12) Patent Application Publication
(10) Pub. No.: US 2007/0122184 A1
(43) Pub. Date: May 31, 2007

(54) Method and apparatus for securing a printing device

(75) Inventors: Harold J. Syring, Little River, TX (US); Michael E. Gleason, Round Rock, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/288,564

(22) Filed: Nov. 29, 2005

(51) Int. Cl. G03G 15/00

(52) U.S. Cl. 399/107

(57) ABSTRACT

A printing device securing apparatus includes a printing device having a first securing member operable to couple to an external locking device. An input tray includes a second securing member operable to couple to an external locking device, wherein the input tray is operable to couple to the printing device such that the first securing member and the second securing member are adjacent. With the input tray coupled to the printing device, an external locking device may be coupled to the first securing member and the second securing member in order to secure the printing device and the input tray if security is an issue.

### BACKGROUND

The present disclosure relates generally to information handling systems, and more particularly to a method and apparatus for securing a printing device which may be coupled to an information handling system.

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information handling systems include a printing device which is coupled to the information handling system. Typical printing devices generally include an input tray which is loaded with a printing medium such as, for example, paper, and coupled to the printing device in order to allow the printing device to access the printing medium and print to it. The securing of the printing device and the input tray raises a number of issues.

In some situations it may be desirable to secure the printing device and the input tray, such as, for example, when a user provides the printing device in a public space such that the printing device and the printing medium are subject to theft.

Conventional printer securing devices generally involve devices that are secured to the printer and a larger entity such as, for example, a table or a wall. However, such conventional solutions do not provide for the securing of the input tray, leaving the printing medium subject to theft. Conventional input tray securing devices provide a built-in lock which allows the input tray to be secured in the printing device in order to protect the printing medium. However, such conventional solutions raise the cost of the printing device, which is undesirable, especially considering that there will be many users who wish to provide the printing device in a private space and hence have no need to secure either the printing device nor the input tray.

Accordingly, it would be desirable to provide a method and apparatus for securing a printing device absent the disadvantages found in the prior methods discussed above.

### SUMMARY

According to one embodiment, a printing device securing apparatus includes a printing device having a first securing member operable to couple to an external locking device, and an input tray including a second securing member operable to couple to an external locking device, wherein the input tray is operable to couple to the printing device such that the first securing member and the second securing member are adjacent.

### BRIEF DESCRIPTION OF THE DRAWINGS

FIG. 1 is a schematic view illustrating an embodiment of an information handling system.

FIG. 2a is a front perspective view illustrating an embodiment of a printing device.

FIG. 2b is a rear perspective view illustrating an embodiment of the printing device of FIG. 2a.

FIG. 2c is a cross sectional view illustrating an embodiment of the printing device of FIG. 2b.

FIG. 3a is a perspective view illustrating an embodiment of an input tray.

FIG. 3b is a cross sectional view illustrating an embodiment of the input tray of FIG. 3a.

FIG. 4 is a perspective view illustrating an embodiment of an external locking device.

FIG. 5a is a flow chart illustrating an embodiment of a method for securing a printing device.

FIG. 5b is a perspective view illustrating an embodiment of the printing device of FIGS. 2a, 2b, and 2c positioned on a securing entity.

FIG. 5c is a perspective view illustrating an embodiment of the input tray of FIG. 3 being coupled to the printing device of FIG. 5b.

FIG. 5d is a cross sectional view illustrating an embodiment of the input tray of FIG. 3 coupled to the printing device of FIG. 5b.

FIG. 5e is a perspective view illustrating an embodiment of the external locking device of FIG. 4 being coupled to the input tray and the printing device of FIGS. 5c and 5d.

FIG. 5f is a perspective view illustrating an embodiment of the external locking device of FIG. 4 being coupled to the input tray and the printing device of FIGS. 5c and 5d.

FIG. 5g is a cross sectional view illustrating an embodiment of the external locking device of FIG. 4 being coupled to the input tray and the printing device of FIGS. 5c and 5d.

FIG. 5h is a cross sectional view illustrating an embodiment of the external locking device of FIG. 4 coupled to the input tray and the printing device of FIGS. 5c and 5d.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

In one embodiment, information handling system 100, FIG. 1, includes a microprocessor 102, which is connected to a bus 104. Bus 104 serves as a connection between microprocessor 102 and other components of computer system 100. An input device 106 is coupled to microprocessor 102 to provide input to microprocessor 102. Examples of input devices include keyboards, touchscreens, and pointing devices such as mouses, trackballs and trackpads. Programs and data are stored on a mass storage device 108, which is coupled to microprocessor 102. Mass storage devices include such devices as hard disks, optical disks, magneto-optical drives, floppy drives and the like. Information handling system 100 further includes a display 110, which is coupled to microprocessor 102 by a video controller 112. A system memory 114 is coupled to microprocessor 102 to provide the microprocessor with fast storage to facilitate execution of computer programs by microprocessor 102. In an embodiment, a chassis 116 houses some or all of the components of information handling system 100. It should be understood that other buses and intermediate circuits can be deployed between the components described above and microprocessor 102 to facilitate interconnection between the components and the microprocessor.

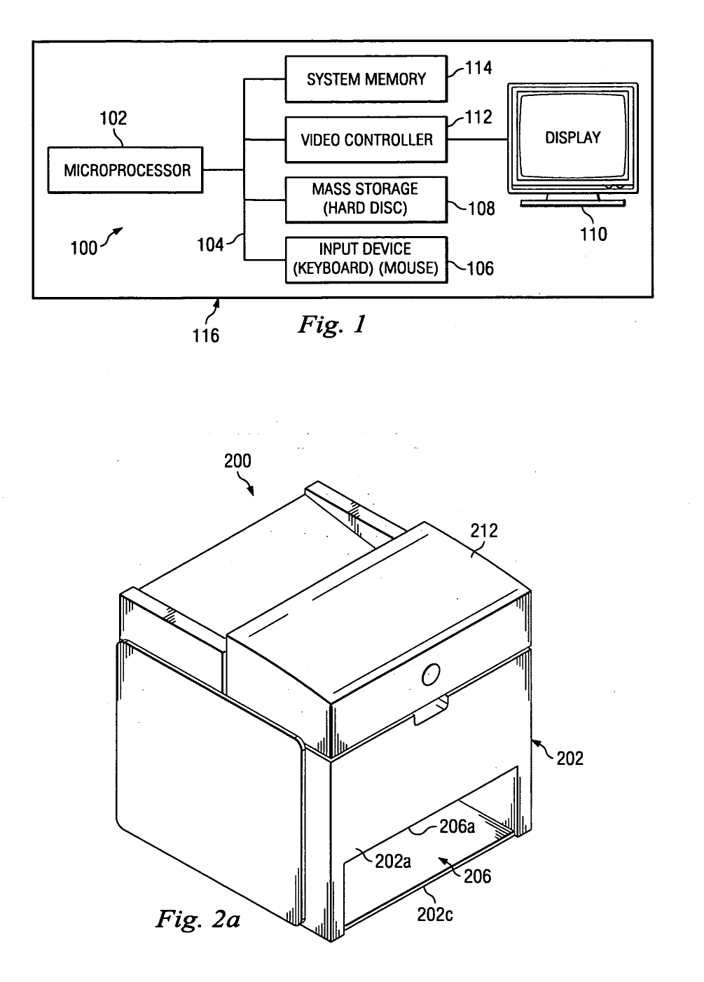

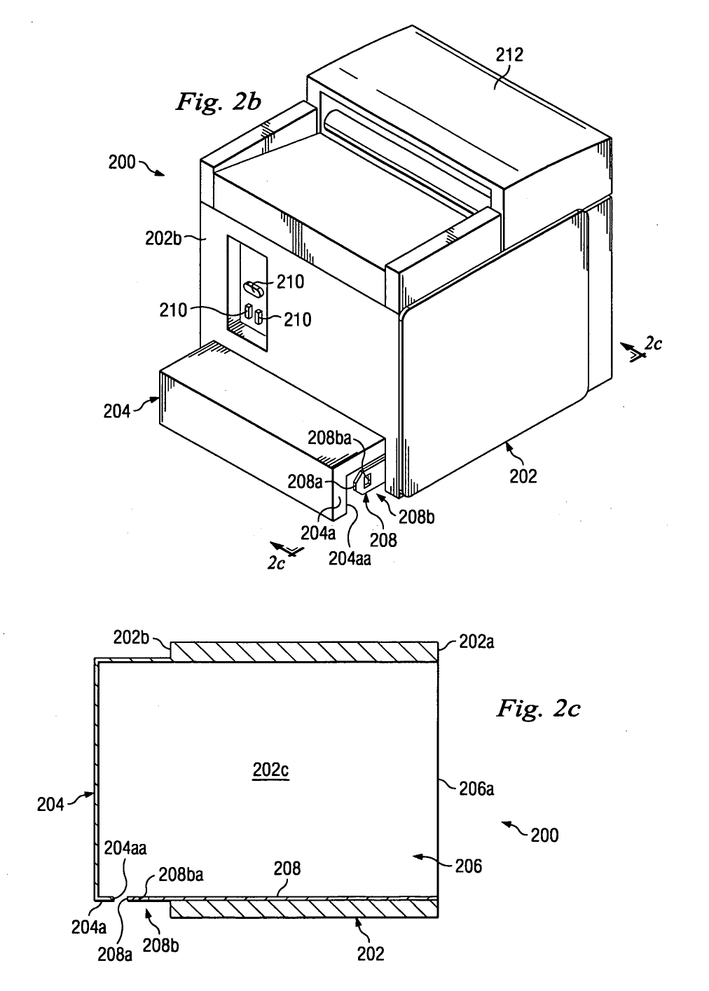

Referring now to FIGS. 2a, 2b, and 2c, a printing device 200 is illustrated. The printing device 200 includes a base 202 having a front surface 202a, a rear surface 202b located opposite the front surface 202a, and a bottom surface 202c extending between the front surface 202a and the rear surface 202b. A base extension 204 extends from the rear surface 202b of the base 202 adjacent the bottom surface 202c. The base extension 204 includes a side surface 204a and defines a securing member opening 204aa through the side surface 204a. The base 202 and the base extension 204 define an input tray passageway 206 which is located adjacent the bottom surface 202c of the base 202 and extends from a passageway entrance 206a to the base extension 204. A first reinforced member 208 is coupled to the base 202 and is located adjacent the input tray passageway 206. The first reinforced member 208 includes a distal end 208a having a first securing member 208b which is located adjacent the securing member opening 204aa and in the input tray passageway 206. In an embodiment, the first securing member 208b is a first slot 208ba which is defined by the first reinforced member 208 and located adjacent the securing member opening 204aa. In an embodiment, the first slot 208ba includes dimensions which are industry standards for a conventional Kensington type lock, available from Kensington Computer Products Group, http://us.kensington.com. A plurality of information handling system connectors 210 are located on the rear surface 202b of the base 202. A printing mechanism 212 is coupled to the base 202 and extends into the base 202 such that the printing mechanism 212 has access to the input tray passageway 206. In an embodiment, the printing mechanism 212 is a conventional printing mechanism known in the art for printing to a printing medium.

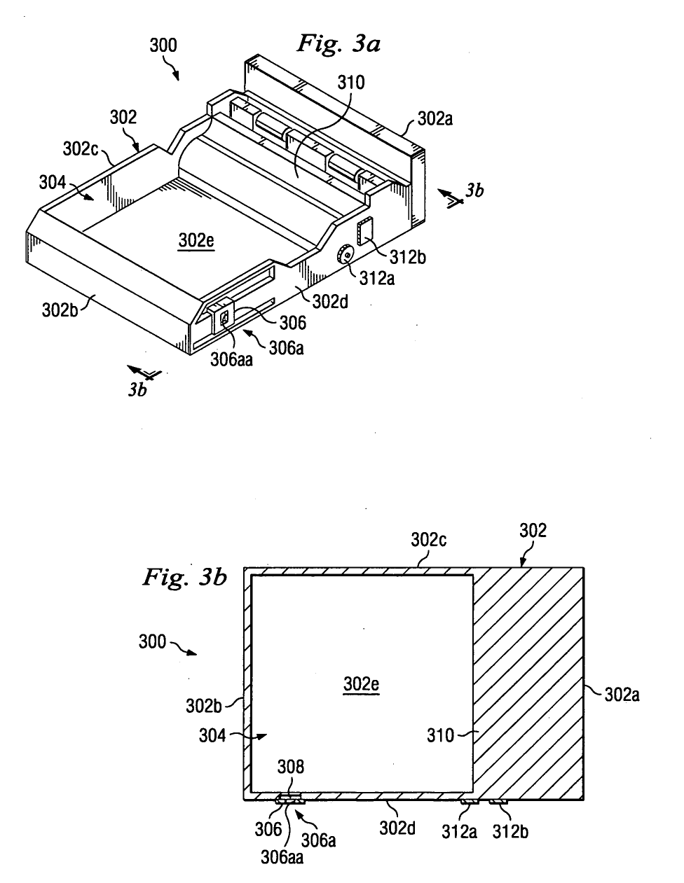

Referring now to FIGS. 3a and 3b, an input tray 300 is illustrated. The input tray 300 includes a base 302 having a front surface 302a, a rear surface 302b located opposite the front surface 302a, a pair of opposing side surfaces 302c and 302d extending between the front surface 302a and the rear surface 302b, and a bottom surface 302e extending between the front surface 302a, the rear surface 302b, and the side surfaces 302c and 302d. A printing medium channel 304 is defined by the base 302 and is located adjacent the bottom surface 302e between the front surface 302a, the rear surface 302b, and the side surfaces 302c and 302d. A second reinforced member 306 is located on the side surface 302d of the base 302 and adjacent the rear surface 302b. The second reinforced member 306 includes a second securing member 306a which is centrally located on the second reinforced member 306. In an embodiment, the second securing member 306a is a second slot 306aa which is defined by the second reinforced member 306a and located adjacent a securing channel 308 which is defined by the base 302. In an embodiment, the second slot 306aa includes dimensions which are industry standards for a conventional Kensington type lock, available from Kensington Computer Products Group, http://us.kensington.com. A feed mechanism 310 is coupled to the input tray 300 and located between the printing medium channel 304 and the front surface 302a of the base 302. A plurality of feed mechanism actuators 312a and 312b are located on the side surface 302d and couple to the feed mechanism 310 through the base 302.

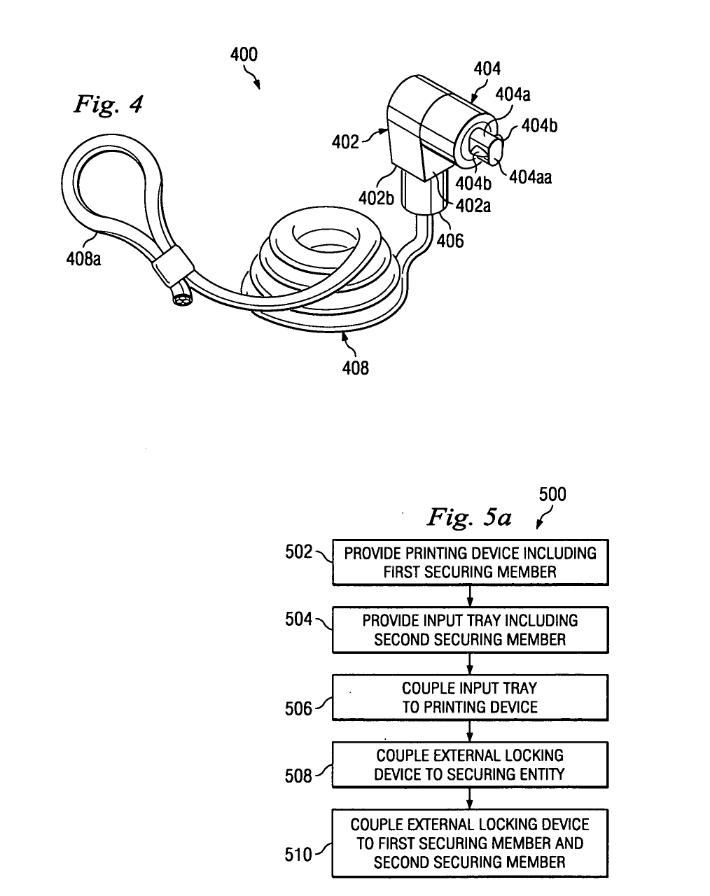

Referring now to FIG. 4, an external locking device 400 is illustrated. The external locking device 400 includes a base 402 having a front surface 402a and a bottom surface 402b oriented substantially perpendicularly to the front surface 402a. A locking member 404 extends from the front surface 402a of the base 402 and includes a beam 404a having a distal end 404aa. A plurality of locking arms 404b extend from opposite sides of the beam 404a and are located adjacent the distal end 404aa. A reinforced member 406 extends from the bottom surface 402b of the base 402, and a cord 408 extends from the reinforced member 406. The cord 408 includes a securing loop 408a located on a distal end of the cord 408. In an embodiment, the external locking device 400 is a conventional Kensington type lock, available from Kensington Computer Products Group, http://us.kensington.com.

Referring now to FIGS. 1, 2b, 5a and 5b, a method 500 for securing a printing device is illustrated. The method 500 begins at step 502 where the printing device 200, described above with reference to FIG. 2b, is provided. In an embodiment, a table securing entity 502a is provided which includes a support surface 502aa and a leg 502ab. The printing device 200 is positioned on the table securing entity 502a such that the bottom surface 202c of the printing device 200 engages the support surface 502aa of the table securing entity 502a. In an embodiment, the table securing entity 502a may be replaced by a variety of different securing entities known in the art such as, for example, a wall or other relatively immobile entity known in the art. In an embodiment, the printing device 200 may be coupled to an information handling system such as, for example, the information handling system 100 described above with reference to FIG. 1, through the information handling system connectors 210.

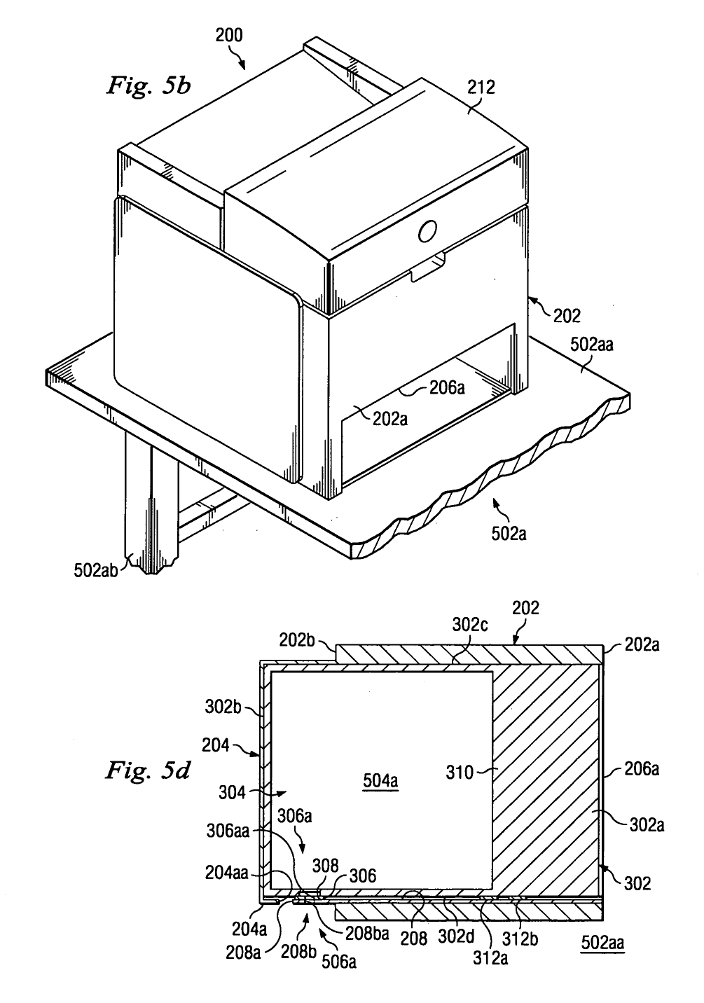

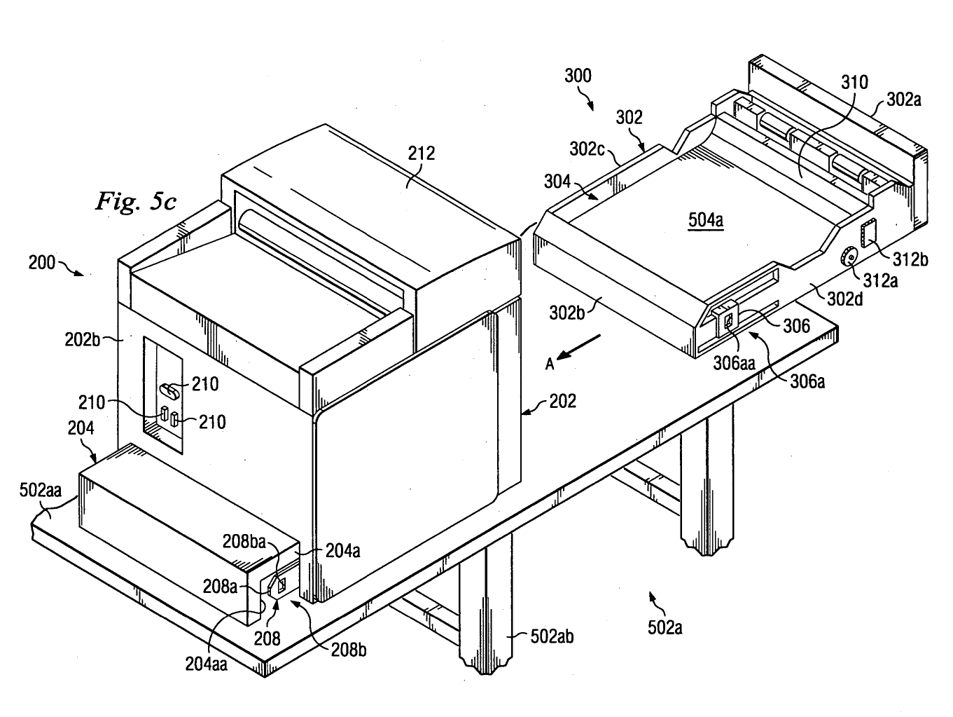

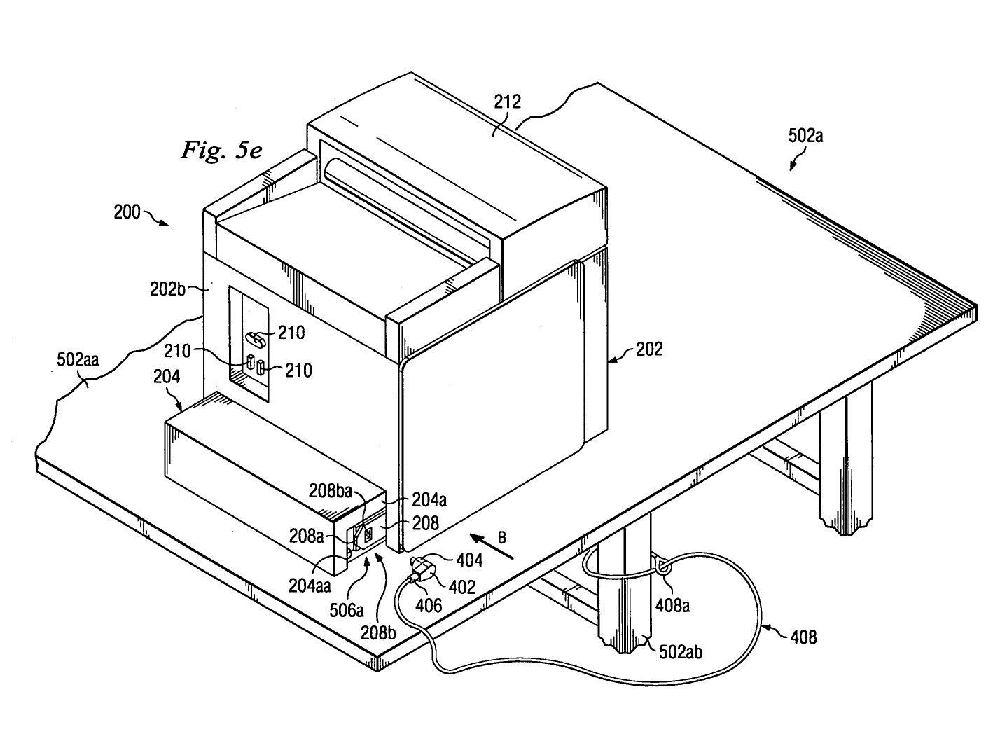

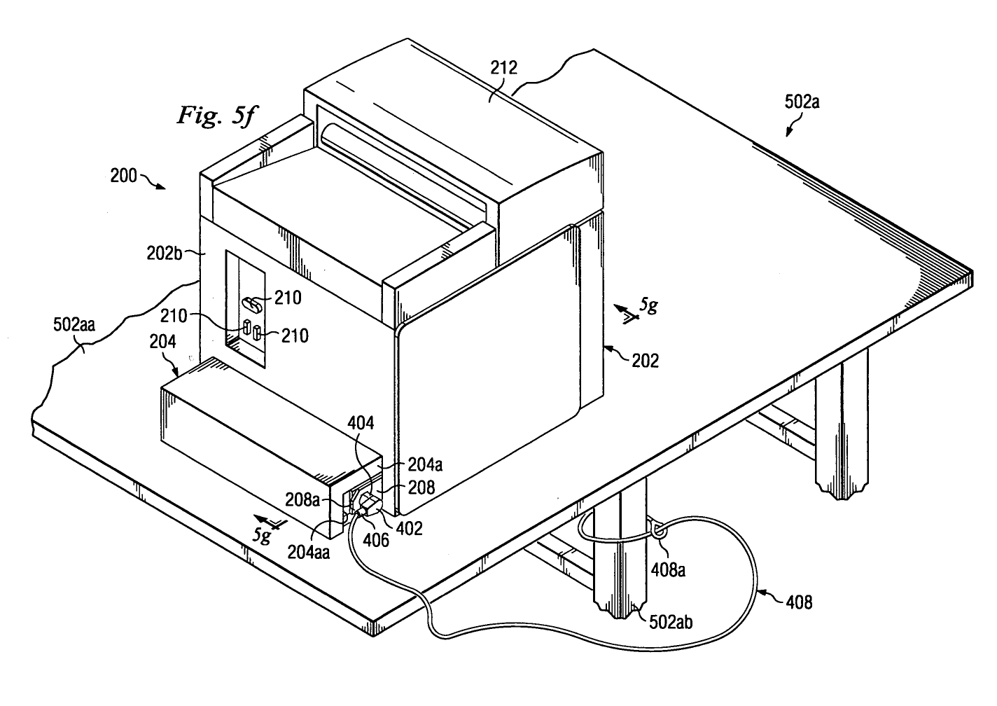

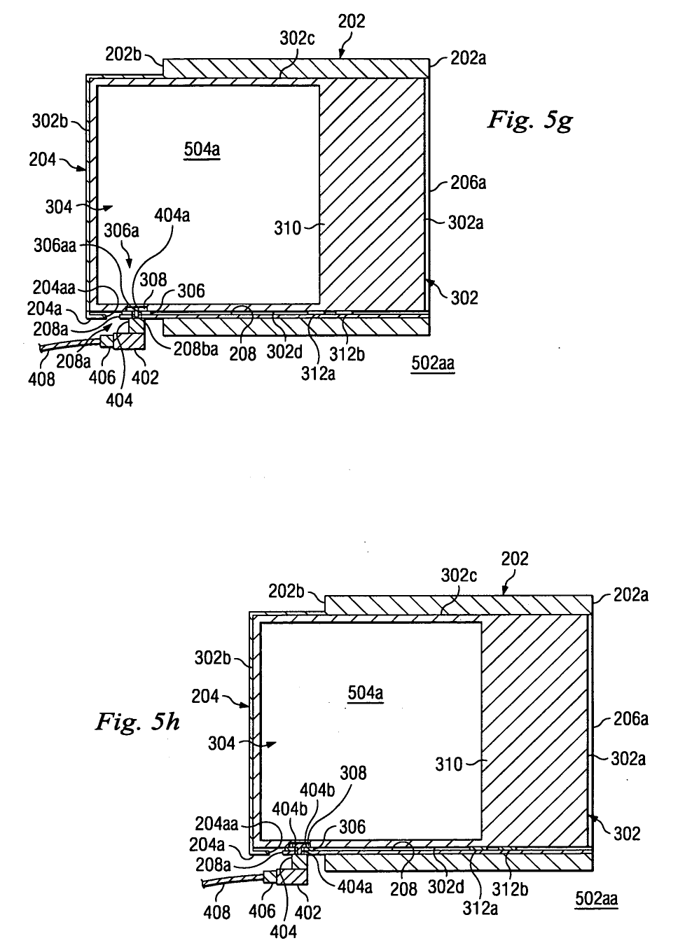

Referring now to FIGS. 2a, 5a, 5c, and 5d, the method 500 proceeds to step 504 where the input tray 300, described above with reference to FIG. 3, is provided. In an embodiment, a printing medium 504a is positioned in the printing medium channel 304. In an embodiment, the printing medium 504a may be a conventional printing medium known in the art such as, paper, photo paper, letterhead, transparencies, cardstock, and a variety of other printing media known in the art. The method 500 then proceeds to step 506 where the input tray 300 is coupled to the printing device 200. The input tray 300 is positioned adjacent the printing device such that the rear surface 302b of the input tray 300 is adjacent the passageway entrance 206a on the front surface 202a of the printing device 200, as illustrated in FIG. 5c. The input tray 300 is then moved in a direction A such that the rear surface 302b of the input tray 300 enters the input tray passageway 206. Continued movement of the input tray 300 in the direction A results in the input tray 300 being coupled to the printing device in the input tray passageway 206, with the rear surface 302b of the input tray 300 engaging the base extension 204 and the second securing member 306a being positioned adjacent the first securing member 208b such that the second slot 306aa on the second securing member 306a is substantially aligned with the first slot 208ba on the first securing member 208b, as illustrated in FIG. 5d. In an embodiment, the first securing member 208b and the second securing member 306a provide a printing device securing apparatus 506a. In an embodiment, the base 202 of printing device 200 includes a drive mechanism which engages the feed mechanism actuators 312a and 312b when the input tray 300 is coupled to the printing device 200. In an embodiment, when security of the printing device 200 and the printing medium 504a is not an issue, the printing mechanism 212 on the printing device 200 may now be used to print to the printing medium 504a.

Referring now to FIGS. 2a, 2b, 2c, 3a, 3b, 4, 5a, 5e, 5f, 5g, and 5h, the method 500 proceeds to step 508 where the external locking device 400, described above with respect to FIG. 4, is coupled to the securing entity 502a. When security of the printing device 200 and the printing medium 504a is an issue, the cord 408 of the external locking device 400 is positioned around the leg 502ab of the securing entity and the base 402 is then pulled through the securing loop 408a, as illustrated in FIG. 5e. In an embodiment, the external locking device 400 may be coupled to a variety of securing entities known in the art using a variety of methods known in the art such as, for example, padlocking the securing loop 408a to an relatively immobile object. The method 500 then proceeds to step 510 where the external locking device 400 is coupled to the first securing member 208b and the second securing member 306a. The locking member 404 of the external locking device 400 is positioned adjacent the securing member opening 204aa such that the beam 404a and the locking arms 404b are aligned with the first slot 208ba and the second slot 306aa. The locking member 404 is then moved in a direction B, as illustrated in FIG. 5e, such that the beam 404a extends through the first slot 208ba and the second slot 306aa and the distal end 404aa of the beam 404a and the locking arms 404b are positioned in the securing channel 308, as illustrated in FIG. 5g. The beam 404a is then rotated about its axis such that the locking arms 404b are moved through the securing channel 308, securing the beam 404a in the first slot 208ba and the second slot 306aa, as illustrated in FIG. 5h, due to the engagement of the locking arms 404b with the second reinforced member 306, and the locking of the locking member 404 to prevent rotation about its axis. The printing device 200 is now secured to the securing entity 502a and the input tray 300 is secured in the printing device 200, preventing theft of the printing device 200 and the printing medium 504a. Thus, a method and apparatus a printing device which is relatively cheap to manufacture and which allows a user to provide an external locking device to secure the printing device and the printing medium if security is an issue. While the first securing member 208b and the second securing member 306a have been illustrated and described including a first slot 208ba and a second slot 306aa which accept a conventional Kensington type lock, a variety of securing members which are known in the art are envisioned to allow the printing device and the input tray to be secured without departing from the teachings of this disclosure.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A printing device securing apparatus, comprising:
a printing device comprising a first securing member operable to couple to an external locking device; and
an input tray comprising a second securing member operable to couple to an external locking device, wherein the input tray is operable to couple to the printing device such that the first securing member and the second securing member are adjacent.

2. The apparatus of claim 1, wherein the printing device defines an input tray passageway.

3. The apparatus of claim 2, wherein the first securing member is located adjacent the input tray passageway.

4. The apparatus of claim 1, wherein the printing device comprises a first reinforced member, whereby the first securing member comprises a first slot defined by the first reinforced member.

5. The apparatus of claim 4, wherein the printing device defines an input tray passageway, whereby the first reinforced member is located adjacent the input tray passageway.

6. The apparatus of claim 1, wherein the input tray comprises a second reinforced member, whereby the second securing member comprises a second slot defined by the second reinforced member.

7. The apparatus of claim 1, wherein the first securing member and the second securing member comprise dimensions for coupling to a Kensington type lock.

8. The apparatus of claim 1, further comprising:
a printing medium positioned in the input tray, whereby the input tray is coupled to the printing device and the first securing member and the second securing member are adjacent.

9. The apparatus of claim 8, further comprising:
an external locking device positioned in the first securing member and the second securing member, whereby the external locking device prevents the input tray from being decoupled from the printing device.

10. An information handling system, comprising:
a microprocessor,
a storage coupled to the microprocessor;
a printing device coupled to the microprocessor, whereby the printing device defines an input tray passageway and a first slot operable to accept an external locking device; and
an input tray defining a second slot operable to accept an external locking device, wherein the input tray is operable to be positioned in the input tray passageway such that the first slot and the second slot are aligned.

11. The system of claim 10, wherein the first slot is located adjacent the input tray passageway.

12. The system of claim 10, wherein the printing device comprises a first reinforced member which defines the first slot.

13. The system of claim 12, wherein the first reinforced member is located adjacent the input tray passageway.

14. The system of claim 10, wherein the input tray comprises a second reinforced member which defines the second slot.

15. The system of claim 10, wherein the first slot and the second slot comprise dimensions for accepting a Kensington type lock.

16. The system of claim 10, further comprising:
a printing medium positioned in the input tray, whereby the input tray is positioned in the input tray passageway and the first slot and the second slot are aligned.

17. The system of claim 16, further comprising:
an external locking device positioned in the first slot and the second slot, whereby the external locking device prevents the input tray from being decoupled from the printing device.

18. The system of claim 17, further comprising:
a securing entity, whereby the printing device is positioned adjacent the securing entity and the external locking device is coupled to the securing entity such that the external locking device secures the printing device to the securing entity.

19. A method for securing a printing device, comprising:
providing a printing device comprising a first securing member operable to couple to an external locking device;
providing an input tray defining a second securing member operable to couple to an external locking device; and
coupling the input tray to the printing device such that the first securing member and the second securing member are adjacent.

20. The method of claim 19, further comprising:
positioning a printing medium in the input tray.

21. The method of claim 20, further providing:
coupling an external locking device to the first securing member and the second securing member.

22. The method of claim 20, further comprising:
coupling the external locking device to a securing entity.
